(19) United States
(12) Patent Application Publication
(10) Pub. No.: US 2002/0136913 A1
(43) Pub. Date: Sep. 26, 2002

(54) Aqueous polymer dispersions for barrier coatings

(75) Inventors: Volker Schaedler, Mannheim (DE); Hermann Seyffer, Heidelberg (DE); Heiko Maas, Mannheim (DE); Andreas Keller, Boehl-lggelheim (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigshafen, DE

(21) Appl. No.: 10/052,409

(22) Filed: Jan. 23, 2002

(30) Foreign Application Priority Data
Jan. 24, 2001 (DE) 101 03 065.7

(51) Int. Cl. B32B 23/08; B05D 3/02

(52) U.S. Cl. 428/512; 427/391; 427/395; 524/836; 524/804; 428/513

(57) ABSTRACT

The invention relates to the use of aqueous polymer dispersions comprising at least one hydrogenated styrene-butadiene copolymer CP, for producing barrier coatings on paper, cardboard, or paperboard.

Aqueous polymer dispersions for barrier coatings The present invention relates to the use of aqueous polymer dispersions for producing barrier coatings on paper, cardboard, or paperboard.

In the packaging industry, packaging materials based on paper, cardboard, or paperboard are frequently provided with a coating to increase the impermeability of the packaging material to water vapor and to flavors, this type of coating of the packaging material also being termed a barrier coating. Packaging materials comprising a barrier coating have varied uses, an example of which is packaging foods, such as herbs and spices, flour, or cereals, and for packaging moisture-sensitive consumer goods, such as washing powders, and also for packaging high-quality papers, such as printer and copier paper. For packaging foods, another important quality criterion is the flavor-impermeability (flavor barrier) of the packaging material.

Materials hitherto used for producing barrier coatings of this type are polyvinylidene chloride (PVDC) and copolymers of vinylidene dichloride. However, materials of this type pose problems of environmental compatibility, in particular in their disposal. There have been many attempts to find chlorine-free polymers to replace polyvinylidene chloride and its copolymers. Thus polyvinyl acetate, poly(meth)acrylates, polyethylene (co)polymers, and comparable substances for producing barrier coatings have been described on various occasions. However, the resultant barrier coatings have unsatisfactory performance characteristics. In particular, sufficient impermeability of these products to water vapor either cannot be obtained or can be obtained only by using a very thick, multilayer structure. The abovementioned products are therefore unacceptable for this application. Although packaging materials comprising a polyethylene/aluminum composite perform well, they are likewise unacceptable from an economic point of view and pose problems of disposal.

The use of aqueous polymer dispersions based on styrene-butadiene copolymers has been described on various occasions for producing barrier coatings on paper. However, the resultant products have only modest impermeability to water vapor. In addition, when products of this type are stored for prolonged periods they have a marked tendency toward yellowing, this being attributable to polymer aging processes induced by heat and/or by UV radiation.

EP-A 393451 describes aqueous preparations which comprise styrene-butadiene copolymer dispersions and at least one paraffin wax. These preparations can be used to produce barrier coatings with improved impermeability to water vapor. However, these coatings have a tendency toward yellowing on storage, in particular when there is exposure to UV radiation or heat, and yellowing is undesirable, not least for esthetic reasons. These aging processes also impair the performance characteristics of the packaging material, e.g. its sealing properties, which play an important part in the packaging of consumer goods. There is also a risk that the impermeability of the barrier coating to water vapor will be reduced by these aging processes.

It is an object of the present invention, therefore, to provide coating compositions for producing barrier coatings which have good impermeability to water vapor and reduced tendency toward yellowing.

We have found that this object is achieved by means of aqueous polymer dispersions based on hydrogenated styrene-butadiene copolymers CP.

The present invention therefore provides the use of aqueous polymer dispersions which comprise at least one hydrogenated styrene-butadiene copolymer CP, for producing barrier coatings on paper, cardboard, or paperboard.

For the purposes of the present invention, styrene-butadiene copolymers are not only copolymers of this type built up exclusively from styrene and butadiene but also copolymers which may incorporate other vinylaromatic monomers besides styrene, and other conjugated diolefins besides butadiene, and may also incorporate the other comonomers usual for this class of substance.

For the purposes of the present invention, hydroggenated styrene-butadiene copolymers CP are copolymers of this type based on the abovementioned styrene-butadiene copolymers in which at least some of the ethylenically unsaturated double bonds resulting from copolymerization of butadiene and, where appropriate, copolymerization of the dienes, generally at least 50 mol%, and in particular at least 70 mol%, based on the total amount of ethylenically unsaturated double bonds, have been hydrogenated. The proportion of hydrogenated double bonds, based on the olefinic double bonds in the underlying non-hydrogenated styrene-butadiene copolymer is also termed the degree of hydrogenation. The degree of hydrogenation of the copolymer CP is therefore generally at least 50%, and preferably at least 70%. The hydrogenated styrene-butadiene copolymers CP particularly preferably have a degree of hydrogenation of at least 80%.

It has moreover proven advantageous for the invention if the glass transition temperature of the hydrogenated copolymer is not lower than −50° C. It is also advantageous for sealability if the glass transition temperature does not exceed +50° C. The glass transition temperature of the copolymer CP is preferably in the range from −40° to +40° C., and in particular in the range from -300 to +30° C. The glass transition temperatures given here are the values determined by DSC (differential scanning calorimetry) using the “midpoint method” to ASTM D3418,823. If the glass transition temperature is below the values given there is a risk that the coated packaging materials still have insufficient blocking resistance and will therefore adhere one to the other. If the glass transition temperature is above the values given it generally becomes impossible to ensure a sufficient level of sealability.

The glass transition temperature of the hydrogenated styrene-butadiene copolymer CP depends, as does the glass transition temperature of the non-hydrogenated styrene-butadiene copolymer, on the ratio of copolymerized butadiene units (and, where appropriate, the copolymerized conjugated diene monomers) to the copolymerized styrene monomer units (and, where appropriate, copolymerized vinylaromatic monomer units). The ratio by weight of structural units which derive from copolymerized diolefins to structural units derived from copolymerized vinylaromatic monomers is therefore generally in the range from 1:4 to 7:3, preferably in the range from 1:2 to 1.7:1.

Hydrogenated copolymers CP preferred for use according to the invention are those which derive from a styrene-butadiene copolymer built up from

i) from 20 to 70% by weight, in particular from 30 to 65% by weight, of at least one monomer A selected from butadiene and isoprene,

ii) from 30 to 80% by weight, in particular from 35 to 70% by weight, of at least one monomer B, encompassing styrene and its mixtures with other vinylaromatic monomers, with acrylonitrile, and/or with methacrylonitrile,

iii) up to 20% by weight, e.g. from 0.1 to 20% by weight, preferably from 0.5 to 10% by weight, and in particular from 0.5 to 5% by weight, of one or more comonomers C other than the monomers A and B.

The styrene-butadiene copolymer preferably contains butadiene as sole monomer A. Preferred monomers B are styrene and its mixtures with up to 20% by weight of acrylonitrile and/or methacrylonitrile, based on the total weight of monomers A to C. Styrene is particularly preferably the sole comonomer B.

Examples of monomers C are ethylenically unsaturated carboxylic acids preferably having from 3 to 8 carbon atoms, such as acrylic acid, methacrylic acid, itaconic acid, and maleic acid, ethylenically unsaturated sulfonic acids and salts of these, e.g. vinyl- and allylsulfonic acid, styrenesulfonic acid, 2-acryloxyethylsulfonic acid, and 2-acrylamido-2-methylpropanesulfonic acid and salts of these, in particular their sodium salts, and also ethylenically unsaturated carboxamides, such as acrylamide, methacrylamide, N-alkylolacrylamides, and N-alkylolmethacrylamides, e.g. N-methylolacrylamide and N-methylolmethacrylamide, and the hydroxyalkyl esters of the abovementioned ethylenically unsaturated carboxylic acids, e.g. hydroxyethyl acrylate, hydroxypropyl acrylate, hydroxybutyl acrylate, hydroxyethyl methacrylate, hydroxypropyl methacrylate, and hydroxybutyl methacrylate. The monomeres C preferably encompass at least one ethylenically unsaturated carboxylic acid having from 3 to 8 carbon atoms, in particular acrylic acid, methacrylic acid, or itaconic acid (carboxylated styrene-butadiene latices), the amount preferably being from 0.5 to 10% by weight, in particular from 1 to 5% by weight, based on the total weight of monomers A, B, and C.

Aqueous dispersions of hydrogenated styrene-butadiene copolymers CP are known from the prior art, for example from DE-A 19753302 and DE-A 19924340. They are prepared by hydrogenating an aqueous dispersion of a styrene-butadiene copolymer in the presence of a hydrogenation catalyst. The styrene-butadiene copolymer to be hydrogenated here generally has the abovementioned makeup.

The hydrogenation catalyst is generally a complex or a salt of ruthenium and/or of rhodium, and generally also encompasses a non-ionic, phosphorus-containing compound which can form a coordinating bond with the transition metal (referred to below as a phosphorus-containing ligand).

The salts and complexes of ruthenium or of rhodium, without any phosphorus-containing ligand for the moment, include the hydrides, oxides, sulfides, nitrates, sulfates, halides, e.g. chlorides, carboxylates, e.g. acetates, propionates, and hexanoates, salts with organosulfonic acids, and also mixed salts, i.e. salts with differing anions, e.g. the oxychlorides of ruthenium and of rhodium.

Salts of complex ions of rhodium and/or of ruthenium are also suitable, for example the salts of oxyacids of rhodium and/or of ruthenium, haloruthenate salts and halorhodate salts, in particular chlororuthenates and chlororhodates, the ammine and aquo complexes of rhodium halides and of ruthenium halides, in particular of the chlorides, and also the salts of nitroruthenates, ruthenium(III) chloride, ruthenium(III) nitrosyl chloride, ammonium pentachloroaquoruthenate(III), hexammineruthenium(II) chloride and hexammineruthenium(III) chloride, dichlorobis(2,2′-dipyridyl)ruthenium(II), tris(2,2′-dipyridyl)ruthenium(II) chloride, pentamminechlororuthenium(III) chloride, potassium pentachloronitrosylruthenium(II), ruthenium(IV) oxide, tetraacetatochlorodiruthenium(II,III), hexakisacetatotriaquo-μ-oxotriruthenium(III) acetate, rhodium(III) chloride, rhodium( III) hydroxide, rhodium( III) nitrate, rhodium( III) sulfate, ammonium pentachloroaquorhodate(III), potassium pentachlororhodate(III), sodium hexachlororhodate(III), triamminetrichlororhodium(III), trisethylenediaminerhodium(III) chloride, rhodium(II) acetate dimer, hexakisacetatotriaquoμ-oxotrisrhodium(III), rhodium(III) hydroxide, rhodium(IV) oxide, and potassium hexanitrorhodate(III).

Other suitable compounds are neutral complexes of rhodium, and also of ruthenium. It should be noted here that the transitions between salts of ruthenium and of rhodium, and also salt-like and neutral complexes, are gradual and the division used here merely serves for classification. Examples of neutral complexes which contain no phosphorus-containing compound are the 2,4-pentanedionates of rhodium and of ruthenium, for example ruthenium(III) tris-2,4-pentanedionate, dicarbonylrhodium(I) 2,4-pentanedionate, rhodium(III) tris-2,4-pentanedionate, bisethylenerhodium(I) 2,4-pentanedionate, and norbornadienerhodium(I) 2,4-pentanedionate, the carbonyl complexes of ruthenium and of rhodium, for example dodecacarbonyltetrarhodium, hexadecacarbonylrhodium, tetracarbonyldi-μ-chlorodirhodium(I), and dodecacarbonyltriruthenium.

Phosphorus-containing ligands which may be used are organic phosphorus-containing compounds where the phosphorus atoms are trivalent. They preferably contain one or two phosphorus atoms.

Examples of preferred phosphorus-containing ligands are the compounds of the formula I

PR₃ (I)

and the compounds of the formula II

R₂P—(O)ₓ—A—(O)y—PR₂ (II)

where

R may be identical or different and, independently of one another, are C₁-C₁₀-alkyl, C₄-C₁₂-cycloalkyl, unsubstituted or C₁-C₄-alkyl-, C₁-C₄-alkoxy-, or halo-substituted phenyl, C₁-C₁₀-alkyloxy, C₄-C₁₂-cycloalkyloxy, aryloxy, or fluorine, or two radicals R together are C₃-C₆-alkylene, C₃-C₆-alkenylene, or C₃-C₆-alkadienylene,

A is a bivalent hydrocarbon radical having up to 25 carbon atoms, and

x and y, independently of one another, are 0 or 1, preferably 0.

Examples of A are linear or branched C₂-C₆-alkylene, such as 1,2-ethylene, 1,2- or 1,3-propylene, 2,3-butylene, 2,2-dimethyl-1,3-propylene, butane-1,4-diyl, where this may have substitution and/or be part of a carbocycle or of a heterocycle, e.g. as in 2,3-(1′,3′-dioxa-2′,2′-dimethylpropane-1′,3′-diyl)butane-1,4-diyl and trans- or cis-norbornane-1,2-diyl. A may also be a bivalent mono-, bi-, or tricyclic radical having phenyl, naphthyl, or anthracenyl groups, and encompasses in particular o-phenylene, o,o-diphenylene, (o,o-diphenylene)methane, 2,2-(o,o-diphenylene)-propane, (o,o-diphenylene)ether, 1,8-naphthylene, 2,2′-binaphthylene, 1,1′-ferrocenylene, 1,9-anthracenylene, 1,9-xanthenylene, where there may be partial or complete halogenation of the phenylene, naphthylene, or anthracenylene groups, and/or these groups may have one or more substituents selected from C₁-C₄-alkyl, C₁-C₄-alkyloxy, amino, di-C₁-C₄-alkylamino, and hydroxyl, which may also have been ethoxylated.

Preferred radicals R are methyl, ethyl, n-propyl, isopropyl, n-butyl, 2-butyl, isobutyl, tert-butyl, n-hexyl, cyclohexyl, cyclopentyl, phenyl, o-, m- or p-tolyl, p-chlorophenyl, p-tert-butylphenyl and p-hydroxyphenyl, in particular n-butyl, 2-butyl, isobutyl, tert-butyl, cyclohexyl and phenyl.

Examples of preferred compounds of the formula I are triphenylphosphine, triisopropylphosphine, tri-n-butylphosphine, tri-n-octylphosphine, tricyclopentylphosphine, tricyclohexylphosphine, trisanisylphosphine, tris(p-tolyl)phosphine, triethyl phosphite, tri-n-butyl phosphite and dibenzophosphole. Examples of preferred compounds of the formula II are 1,2-bis(diphenylphosphino)ethane, 1,3-bis(diphenylphosphino)propane, 1,1′-bis(diphenylphosphino)ferrocene, 2,2′-bis(diphenylphosphino)-1,1′-biphenyl and 2,2′-bis(diphenylphosphino)-1,1′-binaphthyl. Other examples of compounds of the formula II are found in WO 97/33854, Angew. Chem. 1999, 111, p. 349; Applied Homogeneous Catalysis with Organometallic Compounds, Vol. 1 (ed. B. Cornils, W. A. Herrmann) VCH Weinheim, New York 1996.

Complexes of ruthenium with at least one phosphorus-containing compound preferably have the formula III:

Ru X¹X² (CO)ₖ(L¹)₁(L²)₂ (III)

where

X¹ and X², independently of one another, are hydrogen, halogen, preferably chloride, the anion of a carboxylic acid, e.g. acetate, benzoate, or hexanoate, or of a sulfonic acid, e.g. phenylsulfonate, acetylacetonate, or phenyl, where this may have substitution,

k and l, independently of one another, are 0, 1 or 2, with the proviso that k+1=1 or 2,

L¹ has been selected from carbonyl, pyridine, benzonitrile, dibenzophosphole, cycloolefins, and a ligand of the formula PR₃, where R is as defined above, and

L² is a phosphorus-containing ligand of the formula I and (L²)₂ may also be a phosphorus-containing ligand of the formula II. Complexes of rhodium with at least one phosphorus-containing compound preferably have the formula IV:

Rh XₘL³L⁴(L⁵)ₙ (IV)

where

X is halide, preferably chloride or bromide, the anion of a carboxylic acid, acetylacetonate, arylsulfonate or alkylsulfonate, hydride, or the diphenyltriazine anion,

L³, L⁴, and L⁵, independently of one another, are CO, olefins, cycloolefins, benzonitrile, a phosphorus-containing ligand of the formula I or II,

m is 1 or 2, and n is 0, 1, or 2,

with the proviso that at least one of the ligands L³, L⁴, and L⁵ is one of the abovementioned phosphorus-containing ligands of the formula I or II.

X, X¹, and X² in formula III or IV are preferably hydride, chloride, bromide, acetate, tosylate, acetylacetonate, or the diphenyltriazine anion, in particular hydride, chloride, or acetate.

Examples of suitable phosphine complexes of the formulae III and IV are:

carbonylchlorohydridobis(tricyclohexylphosphine)ruthenium(II),

carbonylchlorohydridobis(triisopropylphosphine)ruthenium(II),

carbonylchlorohydridobis(triphenylphosphine)ruthenium(II),

carbonylchlorostyrylbis(tricyclohexylphosphine)ruthenium(II),

carbonylchlorostyrylbis(triisopropylphosphine)ruthenium(II),

carbonylchlorobenzoatobis(triphenylphosphine)ruthenium(II),

dichlorotris(triphenylphosphine)ruthenium(II),

dicarbonylbis(triphenylphosphine)ruthenium chloride,

acetatohydridotris(triphenylphosphine)ruthenium(II),

chlorotris(triphenylphosphine)rhodium(I),

hydridotetrakis(triphenylphosphine)rhodium(I),

hydridotris(dibenzophosphole)rhodium(I).

To carry out the hydrogenation, the hydrogenation catalyst is first incorporated in a suitable manner into the aqueous polymer dispersion of the styrene-butadiene copolymer to be hydrogenated. One method consists in adding the hydrogenation catalyst, or the individual constituents of the hydrogenation catalyst, separately or as a mixture, as solids and/or as solutions, to the polymer dispersion. Another method consists in adding the hydrogenation catalyst, but preferably the rhodium compound and/or ruthenium compound in each case without phosphorus ligands during polymerization of the monomers making up the styrene-butadiene copolymer. If required, the phosphorus-containing compound is then added to the polymer dispersion to be hydrogenated.

The amounts of catalyst required, based on the polymer dispersion to be hydrogenated, are generally from 1 to 1 000 ppm, preferably from 5 to 500 ppm of ruthenium and/or of rhodium, based on the total weight of the polymer to be hydrogenated. The molar ratio of phosphorus-containing compound to the metal atom is generally in the range from 1:10 to 100:1, preferably in the range from 1:2 to 50:1

The solids content of the polymer dispersion to be hydrogenated, based on the styrene-butadiene copolymer present therein, is preferably adjusted to about 20-60% by weight.

For hydrogenation, the catalyst-containing dispersion is then brought into contact with hydrogen in a suitable reaction vessel, where appropriate with prior inertization with regard to oxygen, for example by flushing the reaction vessel with an inert gas, such as nitrogen. The hydrogenation generally takes place at a hydrogen partial pressure in the range from 0.5 to 600 bar, preferably from 50 to 400 bar, in particular from 100 to 300 bar. The reaction temperature is generally in the range from 20 to 250° C., preferably from 50 to 200° C., in particular from 100 to 180° C. The reaction time is generally in the range from 1 to 50 hours, preferably from 2 to 40 hours, and in particular from 3 to 30 hours.

The hydrogenation is generally carried out until the desired degree of hydrogenation has been achieved. This may be determined by the person skilled in the art by methods such as IR spectroscopy, using the typical bands for the ethylenically unsaturated double bonds in the range from 900 to 1000 cm-⁻¹.

The styrene-butadiene copolymer dispersions CP thus obtained feature hydrogenation only at their ethylenically unsaturated double bonds. No, or no significant, hydrogenation occurs at other hydrogenatable double bonds, such as aromatic C═C bonds, carbonyl groups, nitrile functions, or the like.

The styrene-butadiene copolymer aqueous polymer dispersions to be hydrogenated are known from the prior art or may be prepared by processes described in the prior art. They are generally prepared by free-radical aqueous emulsion polymerization of the abovementioned monomers in the presence of polymerization initiators and of surface-active substances. These processes are well known to the skilled worker and are described in detail in the literature, for example in Ullmanns Encyclopedia of Industrial Chemistry, 1^{st} Ed., Vol. A21, p. 373-393.

The publications DE 19753302 and DE 19924340 are incorporated herein by way of reference for further details on the preparation of the polymer dispersions to be hydrogenated, and also on the preparation of the hydrogenated polymer dispersions of the copolymer CP.

The form in which the hydrogenated styrene-butadiene copolymer CP is present in the aqueous polymer dispersions used according to the invention is one of fine division in the aqueous dispersion medium. The weight-average particle sizes of the hydrogenated styrene-butadiene copolymer particles are generally less than 1 μm, preferably in the range from 50 to 500 nm, and particularly preferably in the range from 100 to 400 nm.

The aqueous dispersion medium used may be water or mixtures of water with organic solvents these preferably being water-miscible. The proportion of the solvents is generally not more than 20% by weight, preferably not more than 10% by weight, and in particular not more than 5% by weight, of the dispersion medium. Setting aside any amounts of solvent which may be used for incorporation of the hydrogenation catalyst into the aqueous polymer dispersion, water is preferably the sole dispersion medium. The aqueous polymer dispersions also, of course, comprise the surface-active substances used for the hydrogenation process.

The surface-active substances include the emulsifiers usual for this purpose, and also protective colloids, and mixtures of these. The proportion of the surface-active substances, based on the hydrogenated styrene-butadiene copolymer CP, is generally in the range from 0.5 to 10% by weight. An overview of suitable emulsifiers and protective colloids is given by Houben-Weyl, Methoden der organischen Chemie, Vol. XIV/1, Makromolekulare Stoffe, Georg Thieme-Verlag, Stuttgart 1961, pp. 192-208. Suitable materials are neutral emulsifiers, for example ethoxylated mono-, di-, and trialkylphenols, ethoxylated fatty alcohols, and anionic emulsifiers, such as the alkali metal or ammonium salts of fatty acids, of alkyl sulfates, of sulfuric half-esters of ethoxylated alkanols, of sulfuric half-esters of ethoxylated alkylphenols, of alkylsulfonic acids, and of alkylarylsulfonic acids, and also the alkali metal or ammonium salts of alkylated bis(phenylsulfonic acid)ethers. Examples of suitable protective colloids are polyvinyl alcohol, polyvinylpyrrolidone, amphiphilic block copolymers based on polyethylene oxide, polypropylene oxide, and also phenol- and naphthalenesulfonic acid-formaldehyde condensation products.

The aqueous dispersions of hydrogenated styrene-butadiene copolymers CP may be employed as they stand or in the form of a compounded aqueous preparation. For the purposes of the present invention, a compounded aqueous preparation is a blend of the aqueous polymer dispersions of the hydrogenated copolymers CP with formulation auxiliaries and/or with fillers, as usually used for producing water-vapor and flavor-barrier coatings.

Examples of conventional auxiliaries, besides the protective colloids and emulsifiers used for preparing the dispersions, are antifoams, thickeners, biocides, dispersing aids, and, where appropriate, solvents and plasticizers. The amounts used of the auxiliaries are those which are usual for this purpose. Their proportion by weight, based on the hydrogenated copolymer CP present in the preparation, is generally not more than 10%.

Examples of suitable fillers are fine-particle inorganic materials, such as calcium carbonates, e.g. in the form of chalk, talc, silicates, aluminosilicates, calcium sulfates, and waxes. The proportion of the fillers, if desired, is generally not more than 100 parts by weight, based on 100 parts by weight of polymer in the preparation. In one preferred embodiment of the invention, none of the materials termed auxiliaries or fillers is present in the compounded preparations.

In another embodiment of the present invention, the aqueous dispersions used of the hydrogenated styrene-butadiene copolymers CP are in the form of an aqueous preparation which comprises, besides the hydrogenated styrene-butadiene copolymer CP, at least one dispersed wax. These aqueous preparations may, of course, also comprise the abovementioned amounts of the abovementioned auxiliaries and/or inorganic fillers. However, it is preferable for no fillers to be present in the aqueous preparations in addition to the hydrogenated styrene-butadiene copolymers and the wax.

Examples of suitable waxes are mineral waxes, such as cevesine or ozokerite, petrochemical waxes, such as paraffin waxes, or microwaxes, montan ester waxes, synthetic waxes, such as polyethylene waxes and polypropylene waxes, and also polyethylene glycol waxes, and waxes of vegetable or animal origin, e.g. beeswax and carnauba wax. Preferred waxes are paraffin waxes.

If the aqueous preparations comprise a wax, its proportion is generally in the range from 5 to 100 parts by weight, preferably from 10 to 60 parts by weight, based on 100 parts by weight of hydrogenated styrene-butadiene copolymer CP. Preparations of this type are novel and are likewise provided by the present invention.

The present invention also provides packaging materials made from paper, cardboard, or paperboard, provided with a barrier coating based on a hydrogenated styrene-butadiene copolymer, and also a process for their production.

Packaging materials of this type are produced by a process known per se, by applying, to the substrate to be coated, an aqueous preparation encompassing at least one aqueous dispersion of at least one hydrogenated styrene-butadiene copolymer CP, where appropriate, at least one wax, preferably an aqueous dispersion of a paraffin wax, and also, where appropriate, auxiliaries and/or fillers, and then drying.

Substrates which may be used are in principle any paper, cardboard, or paperboard of a very wide range of weights, smoothness levels, and porosity levels. Examples of suitable substrates are any of the commercially available papers whose weights per unit area are in the range from 60 to 150 g/m², and also commercially available paper- and cardboard with weights per unit of surface area in the range from 150 to 250 g/m².

The application of the coating, i.e. of the aqueous preparation or of the polymer dispersion of the hydrogenated styrene-butadiene copolymer CP takes place using conventional means, such as air brushes, doctors, or reverse gravure systems. Drying may be by contact drying or flotation drying, for example. The drying temperatures are generally above 50° C., preferably above 80° C., e.g. in the range from 50 to 250° C., in particular in the range from 80 to 200° C., and specifically from 100 to 180° C.

Even small applied amounts (coat weights) generally achieve sufficient barrier action for water vapor. The coat weight at which the aqueous preparations encompassing at least one hydrogenated styrene-butadiene copolymer CP are generally applied to the surface to be coated are from 1 to 50 g/m², preferably in the range from 2 to 30 g/m², and in particular in the range from 5 to 20 g/m².

The resultant coated packaging materials feature increased impermeability to water vapor. They also have improved weathering resistance and reduced tendency toward yellowing. Blocking performance, and also sealing performance and impermeability to fats are comparable with those of conventional barrier coatings based on styrene-butadiene copolymer.

The following examples are intended to illustrate the invention but not to restrict the same.

I. Preparation of Styrene-butadiene Copolymer Dispersions to be Hydrogenated

General Preparation Method

3.8 kg of water and seed latex (polystyrene seed, 30 nm) were charged to a polymerization vessel and heated to 90° C. 6 g of sodium peroxodisulfate and 5% by weight of the monomer emulsion were added to this mixture. Beginning at the same time, and holding the temperature constant, 1900 g of a 6% strength by weight aqueous sodium peroxodisulfate solution and the remainder of the monomer emulsion were then added to the polymerization vessel within a period of 4.5 h, via separate feeds. Polymerization was then continued for a further hour, keeping the temperature constant. The content of residual monomers was then reduced to below 10 ppm by a combination of chemical and physical deodorization.

The monomer emulsion had the following makeup:

14.25 kg of a butadiene and styrene monomer mixture

X g of terpinols (see table 1)

440 g of acrylic acid

120 g of sodium lauryl sulfate

Y g of ruthenium(III) tris-2,4-pentanedionate (see table 1)

7.7 kg of water.

The amounts of the starting materials are given in table 1.

TABLE 1

| | | Ru(III)acac₃²⁾ | Terpinols | Tg³ |
|---|---|---|---|---|
| Dispersion | S/Bu¹⁾ | [g] | [g] | [° C.] |
| D1 | 1.85:1 | 0 | 167 | 13 |
| D2 | 1.41:1 | 0.6 | 124 | 5 |
| D3 | 1:1.64 | 0.6 | 116 | −30 |

¹⁾Styrene-butadiene ratio by weight
²⁾Ru(III)acac₃ = ruthenium(III) tris-2,4-pentanedionate
³⁾Glass transition temperature (midpoint value determined by DSC)

II. Hydrogenation of Styrene-butadiene Dispersions

Hydrogenated Dispersion HD1

1113 g of polymer dispersion D1 were adjusted to a solids content of 35% by weight, using 487 g of deionized and deaerated water. To this were added 1.02 g of a solution of 2.54 g of tri-n-butylphosphine and 1.25 g of ruthenium(III) tris-2,4-pentanedionate in 25 ml of toluene. The mixture was stirred for 16 hours at room temperature and then transferred to an autoclave. After inertization, hydrogen was introduced at a pressure of 100 bar. The mixture was heated to 150° C. As soon as this temperature had been achieved, the hydrogen pressure was increased to 280 bar and this pressure was held constant for 15 h. Once the reaction time had ended, the autoclave was cooled, depressurized, and discharged. The properties of the hydrogenated dispersions are given in

TABLE 2

| | | Degree of | |
|---|---|---|---|
| Hydrogenated | Starting | hydrogenation¹⁾ | Tg²⁾ |
| dispersion | dispersion | [%] | [° C.] |
| HD1 | D1 | 81 | 14 |
| HD2 | D2 | 84 | 2 |
| HD3 | D3 | >95 | −23 |

¹⁾Determinedby IR spectrometry
²⁾Glass transition temperature

Hydrogenated Dispersion HD2

Starting from dispersion D2, the reaction took place as for the reaction of dispersion D1, but the solids content set using deionized water was 30% by weight, and 36 mg of solid tri-n-butylphosphine were added instead of the toluene solution of catalyst.

Hydrogenated Dispersion HD3

Starting from dispersion D3, the reaction took place as for the reaction of dispersion D2.

III. Performance Testing

1. Specimens were produced by using conventional coating apparatus, e.g. from the company DIXON, Jagenberg, or Pagendarm, to apply the dispersions to aluminized kraft paper which had a prior coating of about 3 g/m² of an aqueous styrene-butadiene dispersion (Epotal D700, BASF AG). The material was applied using an air brush and a coating rate of 30 m/min. Predrying and drying took place in heated ducts at 140° C. The weight per unit area of the coating on the resultant treated papers is given in table 3.

2. Determination of permeability to water vapor

Permeability to water vapor was determined by a method based on DIN 53122 at 23° C. and 85% relative humidity. The results are given in table 3.

3. Determination of Cobb water absorption

The Cobb method was used to determine water absorption. For the purposes of the present invention, the water absorption is the amount of water in g absorbed by 1 m² of paper surface in a certain time, from water uniformly covering the paper to a depth of 1 cm. The specimen size is 12.5×12.5 cm, and the specimen was preconditioned for moisture content under standard conditions of temperature and humidity. Table 3 gives the amount of water absorbed within 30 min.

TABLE 3

| | Coat | PWV¹⁾ | COBB (30 min) |
|---|---|---|---|
| Dispersion | g/m² | g/m²/24 h | g/m² |
| D1 | 10 | 41.1 | 2.75 |
| HD1 | 6.6 | 30.5 | 2.64 |
| D2 | 9 | 42.2 | 5.36 |
| HD2 | 10 | 25.2 | 3.4 |
| D3 | 10.3 | 65.4 | 4.3 |
| HD3 | 9.4 | 34.3 | 4.5 |
| 0.8 HD2 + 0.2 wax² | 10 | 2.4 | n.d. |

¹⁾Permeability to water vapor
²⁾Blend made from 0.8 parts by weight of dispersion HD2 and 0.2 parts by weight of a commercially available paraffin wax

The blocking performance, oilproof properties (pore density) and sealing performance of papers coated with the hydrogenated styrene-butadiene copolymers were comparable with those of papers which had been coated with non-hydrogenated styrene-butadiene copolymer dispersions.

We claim:

1. A method for coating paper, cardboard, or paperboard, which comprises applying, to the substrate to be coated, an aqueous preparation encompassing at least one aqueous polymer dispersion of at least one hydrogenated styrene-butadiene copolymer CP, where appropriate a wax dispersed in the aqueous phase, and also, where appropriate, conventional auxiliaries and fillers, and then drying at an elevated temperature.

2. The method as claimed in claim 1, where the hydrogenated copolymer CP has a degree of hydrogenation of at least 70%, based on ethylenically unsaturated double bonds.

3. The method as claimed in claim 1, where the hydrogenated copolymer has a glass transition temperature in the range from −40 to +40° C.

4. The method as claimed in claim 1, where the hydrogenated copolymer CP derives from a styrene-butadiene copolymer built up from:
i) from 20 to 70% by weight of at least one monomer A selected from butadiene and isoprene,
ii) from 30 to 80% by weight of at least one monomer B, encompassing styrene and its mixtures with other vinylaromatic monomers, with acrylonitrile, and/or with methacrylonitrile,
iii) up to 20% by weight of one or more monomers C other than the monomers A and B.

5. The method as claimed in claim 4, where the monomer C has been selected from ethylenically unsaturated carboxylic acids, ethylenically unsaturated sulfonic acids, ethylenically unsaturated carboxamides, and hydroxyalkyl esters of ethylenically unsaturated carboxylic acids.

6. The method as claimed in claim 1, where the polymer particles of the hydrogenated copolymer CP in the aqueous dispersion have a weight-average particle diameter in the range from 50 to 500 nm.

7. The method as claimed in any of the preceding claims, where the aqueous polymer dispersion of the hydrogenated copolymer CP also comprises at least one wax dispersed in the aqueous phase.

8. The method as claimed in claim 7, where the wax is a paraffin wax.

9. A method as claimed in claim 1, wherein the dry coating weight per unit area at which the dispersion of the at least one copolymer CP is applied to the surface to be coated is from 1 to 50 g/m².

10. A packaging material made from paper, cardboard, or paperboard with a polymer-based barrier coating, wherein the polymer is a hydrogenated styrene-butadiene copolymer CP.

11. An aqueous preparation encompassing at least one aqueous dispersion of a hydrogenated styrene-butadiene copolymer CP and at least one wax dispersed in the aqueous phase, and, where appropriate, conventional auxiliaries and/or fillers.
